(19) United States
(12) Patent Application Publication
(10) Pub. No.: US 2010/0156580 A1
(43) Pub. Date: Jun. 24, 2010

(54) SAFETY APPARATUS

(76) Inventors: Martin Bill, Nohfelden (DE); Patric Fuchs, Saarbrucken (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/452,901

(22) PCT Filed: Jun. 18, 2008
(86) PCT No.: PCT/EP2008/004884

§ 371 Date: Feb. 22, 2010

(30) Foreign Application Priority Data
Jul. 31, 2007 (DE) 10 2007 036 310.0

(51) Int. Cl. H01F 7/06

(52) U.S. Cl. 335/219

(57) ABSTRACT

The invention relates to a safety apparatus for avoiding a possible fire risk in an operating magnet which can be supplied with electric current, having at least one coil former (14) which is arranged in a housing (76, 82) and on which a coil winding (16) is fitted, and having an operating part (20, 36) which is at least partially guided in the coil former (14). As a result of at least parts of the operating magnet being equipped with active and/or passive safety means of the apparatus in order to effectively counteract the risk of fire, the safety means are no longer arranged remote from the actual event, for example in the form of a fuse in the electrical supply circuit, but rather directly at the location of the event where the possible fire or scorching situation can directly occur.

The invention relates to a safety apparatus for avoiding a potential fire risk in an operating magnet that can be supplied with electric current, with at least one coil former that is arranged in a housing and on which a coil winding is fitted, and with an operating part that is at least partially guided in the coil former.

Such operating magnets that can be supplied with electric current are readily available on the market in a number of embodiments. By way of example, reference is made to the previously known solution according to DE 10 2004 017 089 B4 as representative of the pertinent operating equipment, in particular in the form of a proportional double solenoid. The known solution is used in the operation of valves, with at least two on one coil former in each case, the coil windings arranged in each case between two ring flanges, which at least partially encase a pole tube, by an anchor part being guided movably, which undergoes transition into a pole core at its one end via a magnetic separation, in which pole core an operating plunger is guided as an operating part, and with its other end said anchor part at least partially engages a closing part via another magnetic separation, a disk-shaped pole plate being arranged between the adjacent and opposing coil formers. In the known solution, the pole core, the pole tube, as well as the magnetic separations and the closing part form an assembly, onto which the respective coil former with its coil windings and the pole plate can be slipped as another assembly. To always have a defined securing position, it is provided that at least one of the facing ring flanges that are adjacent to one another has a projecting component, which can be engaged with a corresponding recess in the ring flange of the other coil former. As already mentioned above, such operating magnets are used primarily to control hydraulic valves; however, new technical areas are increasingly opening up for which respective operating magnets can be used advantageously.

Thus, the subsequently published DE 10 2005 056 816 shows an unlatching device with use of an operating magnet for emergency activation of a headrest for a motor vehicle seat, which, in the event the motor vehicle crashes, moves forward in order thereby to reduce the free impact surface between the back of the seat user's head and the impact area of the head on the headrest. To control the unlatching of the headrest, a corresponding control part is used that can be moved along a first axis and that, in an operating position, enables a swing distance running crosswise to the first axis for a control device, which is arranged to pivot around a second axis. The respective control device also has a locking part that can be unlatched by means of the operating part of the magnet via the control device and then the pathway for the control part to be triggered releases in the forward direction for an activation process of the headrest.

The problem common to all operating magnets with their coil windings is that in the event of fault currents, overheating caused by overstraining the magnet, etc., can result in fire, and since plastic materials are used increasingly for weight and practicality reasons for at least one portion of the components of the operating magnet, which can easily scorch or even burn, the risk increases accordingly that, starting from the electrical coil winding via the above-mentioned plastic parts, a fire has a detrimental effect on other connected components of the technical system, such as valves, headrests, etc. Thus, currently both the housing parts of the operating magnet and their encapsulation are made of plastic, and other relevant plastic parts are the coil formers for receiving the coil winding and the plastic insulating layers for the wire winding that is fitted to the coil former, usually designed in the form of copper wire.

Preferably, the pertinent copper wire, as a coated electric wire, is encased over its entire length with a so-called plastic coated insulation in order thereby to have an electric decoupling between the winding layers in the winding; however, the pertinent plastic coated insulation is very heat-sensitive, easily scorches through, and thus forms an ideal fire source. The approach is to counteract the pertinent fire risk in practice in that an electric safety device is installed within the electric supply cycle of the coil winding, primarily in the form of a fuse that is to activate, i.e., is to break, the electric circuit as soon as a short-circuit occurs because of scorched parts of the coating insulation; in practice, however, the cases show that this is not sufficient to effectively counteract the potential fire risk. Thus, there have been cases in which the fuse indeed activated and nevertheless a (scorching) fire resulted because of a short-circuit, starting from the pertinent operating magnet that was used.

Starting from this prior art, the object of the invention is therefore to improve the known safety devices so that there is no scorching and the progression to a fire starting from a respective operating magnet that is used. This object is achieved with a safety apparatus with the features of claim 1 in its entirety.

In that, as specified in the characterizing part of claim 1, in the safety apparatus according to the invention, it is provided that at least portions of the operating magnet are equipped with active and/or passive safety means to counteract the fire risk effectively, the safety means are no longer outside of the actual event, for example arranged in the form of a fuse in the electrical supply circuit, but rather directly on site, where the potential fire or scorching situation can occur directly. Thus, without a significant delay, there is a direct influence of the safety apparatus, which accordingly becomes an integrated component of the operating magnet. Independently of this, however, to increase safety, there is no reason not to provide additional electric safety devices, such as conventional fuses, in the electric circuit, which may already be provided on site in the existing electric circuits. Thus, an especially reliable, redundant safety design is produced.

In a preferred embodiment of the safety apparatus according to the invention, it is provided that an extinguishing medium is used as an active safety means, such as extinguishing foam, extinguishing gas and extinguishing fluid with inclusion of nanoparticulate extinguishing substances. In addition to the active safety means for which a storage space is preferably provided within the operating magnets, passive safety means can also be used, so that the latter are integrated parts of components of the operating magnets. Thus, the plastic parts of the operating magnets can be equipped with flame-resistant or flame-retardant active substance, or else existing systems can be retrofitted.

In an especially preferred embodiment of the safety apparatus according to the invention, it is provided, however, that safety means are used that serve in the production of a type of scoring for creating an early, non-critical failure case for the operating magnets. For inducing the early failure case, an electrical short-circuit of the coil winding is created, in which the latter is selected from an insulating material class for the material of its sheathing, which melts in time before reaching the critical temperature for a fire. While a very heat-resistant coating insulation according to DIN EN 60317 is normally selected in the prior art for the copper wire of the coil winding to ensure high operating safety and relies on the fuse responding quickly, which cannot be ensured, as explained, the safety apparatus according to the invention takes a different approach by a coating insulation for the coil wire being used, which has a low softening temperature, such that if even just a little warmth or heat develops within presettable limits, a desired burning-through of the adjacent insulating layers occurs.

This has the result that the coil winding is melted together, at least partially, to form a copper block that consists of the individual winding layers, whereby said block is not easily destroyed by heat and which in particular disables the operating magnets—which also affects additional current draw. Practical tests have shown that the safety apparatus according to the invention manages even without the additional fuse solution in the electric supply circuit for the coil winding and that, in any case, the fire risk is effectively counteracted by the early melting down of the insulation.

Other advantageous embodiments of the solution according to the invention are the subject matter of the other dependent claims.

Below, the safety apparatus according to the invention is explained in more detail based on an embodiment according to the drawing. The figures are schematic and not to scale, in which,

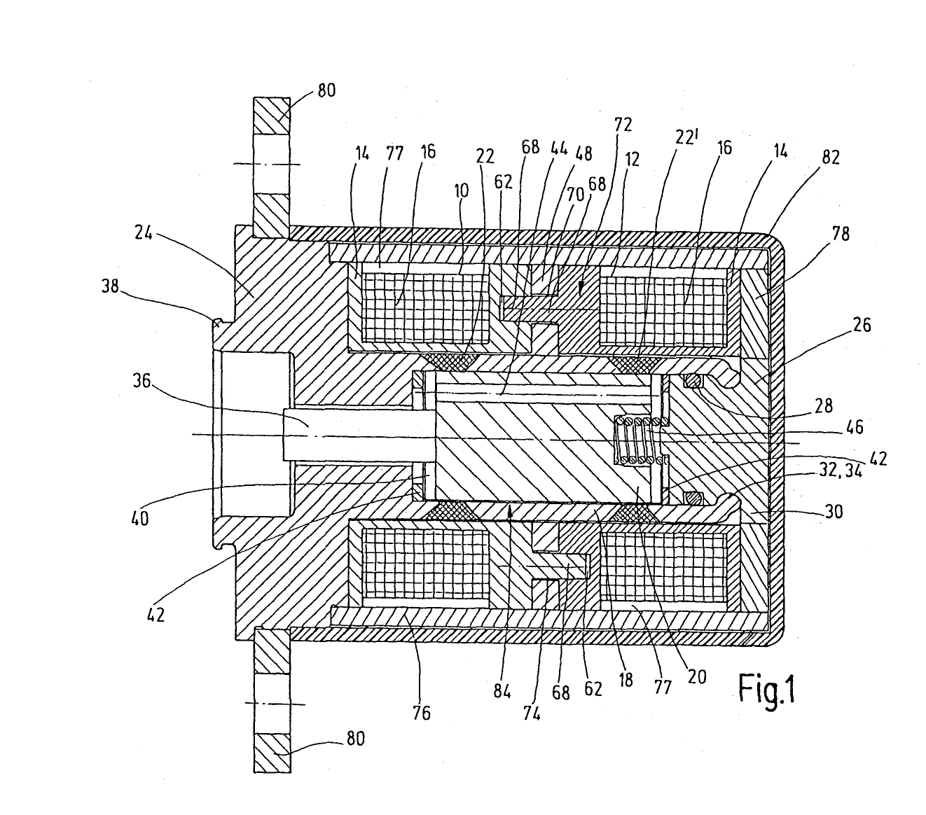

FIG. 1 shows a longitudinal section through a double solenoid;

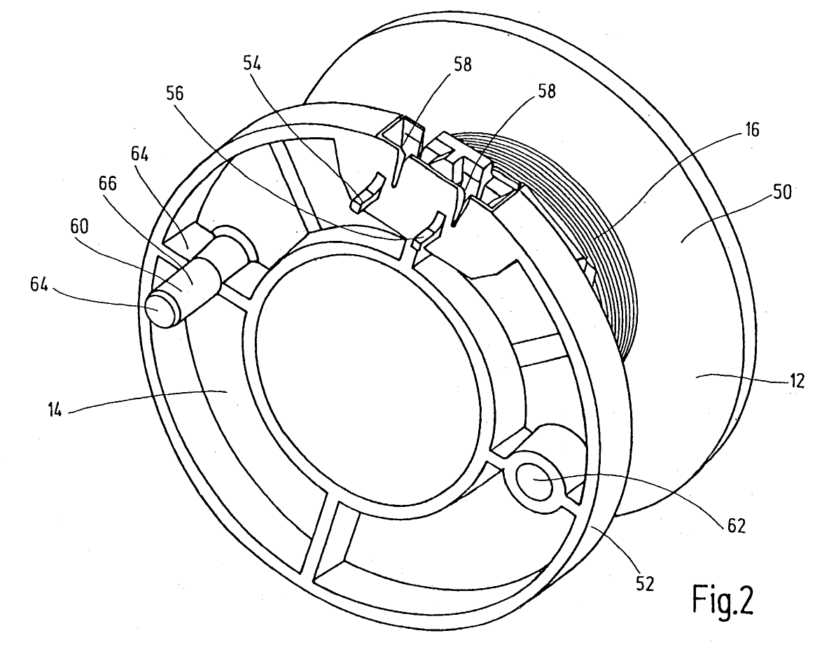

FIG. 2 in a perspective view, shows an individual coil for the magnets according to FIG. 1 with a coil winding fitted partially to the coil former;

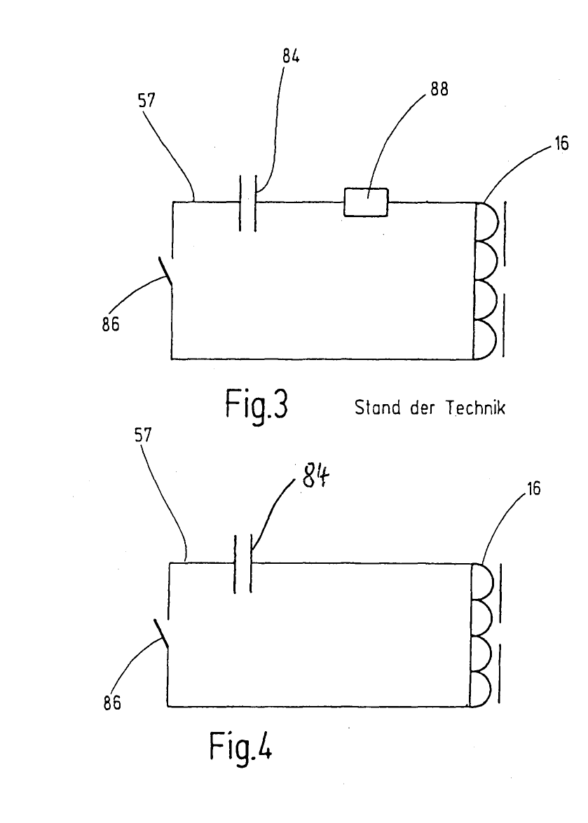

FIGS. 3 and 4, in the form of wiring diagrams, show the power supply for the coil winding of an operating magnet; one with and one without a fuse.

The operating device that is shown in longitudinal section in FIG. 1 is designed in the form of a so-called double solenoid, in particular in the form of a proportional double solenoid, which is used primarily to operate hydraulic or pneumatic valves, not shown in more detail. Comparable operating magnets, also in the form of an individual solenoid, can be used for valve control, but are also used in the activation of safety devices, such as a headrest activation, shown in DE 10 2005 056 816. The operating device shown in FIG. 1 has two coils 10, 12, each coil 10, 12 being provided with a coil former 14, on which a coil winding 16 is fitted, for example in the form of a coated electric wire, preferably in the form of a copper wire. The design of the respective coils is conventional in magnet technology, so that at this point, no further detail will be provided. The two coils 10, 12 comprise a pole tube 18, in which an anchor part 20 can move longitudinally and is guided to move within.

Viewed in the direction of looking at FIG. 1, the pole tube 18 is connected at its front end via a first magnetic separation 22 to the pole core 24 that is spread like a flange and on its other side, likewise via a second magnetic separation 24, to a closing part 26. Pole tube 18 and pole core 24 are designed in one piece from a magnetically conductive metal material and can be designed, for example, as a rotating part. By machining, groovelike recesses can be obtained in the pole tube 18, which then preferably are filled via a welding or soldering application process with a magnetically non-conductive material, which then forms the respective magnetic separation 22 or 22′. The closing part 26 is then connected behind the second magnetic separation 22′, which is provided on the outside circumferential side with an annular groove, in which a sealing ring 28 is inserted. Toward the free end, the pole tube 18 is flanged toward the inside, and a groovelike recess 32 is provided in the latter between the anchor part 20 and a shoulder 30, extended like a web, of the closing part 26, into said recess, the pole tube end 34 engaging by friction and positive action. The pertinent arrangement between pole tube 18 and closing part 26 in connection with the sealing ring 28 allows a high-pressure application of the double solenoid up to 250 bar and more.

On its front end, the anchor part 20 has an actuating tappet 36 and together with the latter forms an operating part that is guided at least partially into the respective coil former 14. The actuating tappet 36 also engages the pole core 24 in the center and is provided for operating a hydraulic valve, not shown in more detail, of a safety device for a headrest, etc., whereby the pertinent additional system parts can be connected via a connecting point 38 to the pole core 24 with the operating device. The anchor part 20 is guided in a receiving space 40 between two anti-adhesive disks 42, which help to prevent magnetic adhesion of the anchor part 20. The receiving space 40 is limited, on the one side, by the inner circumferential side of the pole tube 18 as well as forward through the pole core 24, and, on the other side, by the closing part 26. In addition, the anchor part 20 has a through-hole 44, which produces pressure equalization within the receiving space 40, if the latter is divided by the anchor part 20 into two partial spaces. The maximum longitudinal travel of the anchor part 20 is set by the stops in the form of the anti-adhesive disks 42.

Furthermore, viewed in the direction looking at FIG. 1, the anchor part 20 is supported on the right side on a pressure spring 46, whereby another pressure spring, not shown and having an opposite effect, can be arranged in the hydraulic or pneumatic valve, or in a safety device, optionally to produce a counterforce via the actuating tappet 36 on the anchor part 20. With the pertinent application of a force, the anchor part 20, as shown in FIG. 1, can be centered in the middle, it being possible to further support the above-mentioned middle-centering by sending current through both coils 10, 12 via their respective coil winding 16, and travel of the anchor part 20 then takes place in one direction or the other (pulling or pushing) by sending the corresponding additional current through the coil 10 or 12 that can be assigned in each case. Between the two coils 10, 12, a disklike pole plate 48 is arranged, which likewise encompasses the pole tube 18.

The design of an individual coil 12 is reproduced by way of example in FIG. 2. In addition to the actual coil winding 16, the coil 12 has two ring flanges 50, 52 wound on the coil former 14. Preferably, the pertinent coil former 14 is formed from an injection-molded part and has two connection points 54, 56 on its top side viewed in the direction looking at FIG. 2, via which in each case the beginning and end (not shown) of the coil winding 16 can be fixed on the assignable coil former 14. Furthermore, the two connection points 54, 56 are used for the connection of the coil winding 16 to a power supply circuit 57 of the conventional design according to the depictions of FIGS. 3 and 4. For a pertinent electrical connection with the supply circuit 57, in addition, two recesses 58 that are arranged on the top side of the ring flange 52 are used, which in turn are used in the engagement of a contact device, not shown in more detail, in order thereby to produce the above-mentioned electrical connection to a plug-in part (not shown) of the power supply circuit 57 to the connection points 54, 56. In particular, the respective wire end of the coil winding 16 here engages the ring flange 52 that runs crosswise to the recess 58.

Viewed in the direction of looking at FIG. 2 and offset by about 90° in each case to the connection points 54, 56, a projecting component 60 is arranged on one side, and a corresponding recess 62 is arranged on the diametrically opposite side. The projecting component 60 is accommodated in a stiffening web 64, which is a component of the chamber-like ring flange 52. A cylindrical middle part 66 of the projecting component 60, which undergoes transition into a contact pin 68 with a conical taper, is connected to this stiffening web 64. The pertinent contact pin 68 with a conical taper is provided to engage in the conical recess 62 of the ring flange 52 of the other coil 10, which otherwise is designed as the same part as the coil 12. Also, the cylindrical middle part 66 of the projecting component 60 is used in the penetration of the through-opening 70 in the center pole plate 48. To facilitate the engagement of the projecting component 60 in the assignable recess 62, the latter is likewise provided on the inside circumferential side with a corresponding conicity.

The coils 10, 12, which are designed as like parts, are then, viewed in the direction of looking at FIG. 2, to be brought together, offset by 180° to one another, via their ring flange 52 with intermediate accommodation of the pole plate 48 between the adjacent ring flanges 52, in order to then obtain a coil former design, as is the subject of the depiction according to FIG. 1, and to this extent forms another second assembly that is referred to as a whole with 72. To be able to have the connection points 54, 56 of any ring flange 52 face one another, a recess 74 is made in the middle pole plate 48 according to the depiction of FIG. 1.

As follows in addition from FIG. 1, the two coils 10, 12 are encased on the outside by a cylindrical jacket 76 that in turn consists of magnetically conducting material. In this embodiment, an annular cavity 77 is formed between the outside circumference of the coil winding 16 and the inside circumferential side of the jacket 76. The pertinent cavity 77 can be used, for example, to receive an extinguishing agent, which is to be explained in more detail below. The formation of various other cavities would be conceivable, for example, in the area of the connection of the pole tube end 34 to the shoulder 30, extended like a web, of the closing part 26 or in the area of the compression spring 46. The provision of additional cavities for filling with a respective extinguishing medium would be conceivable based on the space available. Also, supplying an extinguishing medium from outside is conceivable, in which a storage container, mounted from the outside on the operating magnets, is in media-carrying connection with inside parts of the depicted operating apparatus.

The above-mentioned cylindrical jacket 76 is connected once on the end side via drive fit with a shoulder-like stage in the pole core 24 with the latter and once with a pole closing plate 78, which is supported on the inner circumferential side on the shoulder 30 of the closing part 26. The pole core 24 has, moreover, two attachment flanges 80 in the direction of its free end, and said flanges that with corresponding through-openings provide the penetration of fastening screws, not shown in more detail, are used for the purpose of securing valve or safety housing parts, not shown in more detail, to which the operating device is to be connected. In this respect, the operating device is also designed in the form of a modular design concept. From the attachment flanges 80, the remainder of the operating apparatus is encased on the outer circumferential side by a housing part 82, which in particular, if it consists of plastic, can be sprayed onto the other components, preferably in a sealing manner.

The double solenoid presented here can be seen only by way of example; of course, instead of the double solenoid, an individual solenoid can also be used, as it is shown in this form or a similar form in DE 10 2005 056 816. In this respect, the actuating tappet 36 (not shown) can then also be provided via the free front edge of the operating magnet.

The now presented operating magnet in the form of an operating apparatus is provided according to the invention with a safety apparatus for avoiding a possible fire risk, by at least parts of the operating magnet being equipped with active and/or passive safety means. As active safety means, for example, extinguishing media can be provided, such as extinguishing foam, extinguishing gas, or extinguishing fluid with inclusion of nanoparticulate extinguishing substances, for example based on gel.

If nitrogen is to be used as an extinguishing gas, melamine or melamine-containing active compounds have proven reliable as nitrogen vehicles. As an extinguishing fluid for the discharge of water, aluminum trihydroxide (ATH) and/or magnesium hydroxide (MDH), also in capsule or paste-like form, can be used successfully. As an extinguishing foam, ammonium polyphosphates (APP) are suitable, and as nanoparticulate extinguishing substances, silicate and/or graphite can be used, for example, by being integrated in a gel-based substance. The pertinent extinguishing media can be housed in, for example, the above-mentioned cavity 77 between the outside of the respective coil winding 16 and the inside of the jacket 76. Because of the good active sealing situation for the operating magnets, the pertinent extinguishing media can also be encapsulated over the long term in the cavity 77. If, for example, a medium connection to the area encasing the operating magnet is created via a hole, the respective cavity 77 could also be filled initially or else subsequently be refilled from the outside with the extinguishing medium if existing operating equipment is already present. Furthermore, a storage apparatus (not shown) that is mounted on the magnet could permanently provide for a fresh supply of extinguishing medium especially in case of an emergency. If a malfunction or failure occurs with strong heating of the respective coil winding 16, the pertinent extinguishing media are suitable to draw off the heat energy that is produced and, moreover, to control it.

In addition to or as an alternative to the described active safety means, so-called passive safety means can also be used, which are characterized in that they have low flammability or have a flame-retardant action. As passive safety means, especially materials such as the following are used here:
ammonium phosphate (AP)
ammonium polyphosphate (APP)
resorcinol bis-diphenylphosphate (PDP)
red phosphorus (RP)
tri-n-butyl phosphate (TBP)
tricresyl phosphate (TCP)
triphenyl phosphate (TPP).

The pertinent materials act in particular when they are at least partial components of the housing, for example in the form of the closing part 26 or in the form of the plastic encapsulation 82 of the housing. Moreover, these can be components of the respective coil former 10, 12 or even form the electric jacket insulation of the respective coil winding 16. In particular, when the above-mentioned components are formed from pertinent plastic materials, the passive safety means can be very well intermixed or used cluster-like even subsequently in the respective plastic walls.

In addition to or as an alternative to the described active and passive safety means, another safety means can be produced in the form of a scoring for creating an early, non-critical failure case for the operating magnets. The pertinent scoring situation is to be explained in more detail based on the embodiment according to FIGS. 3 and 4. In this case, FIG. 3 shows a solution according to the prior art. As mentioned above, the respective coil winding 16 is connected via a corresponding electrical supply circuit 57 to a power supply source, for example in the form of a battery. By closing a switch 86, the coil winding 16 can be supplied with power via the battery 84 in order thereby to be able to activate operating processes. In addition, the pertinent electric supply circuit 57 is secured via a safety device, such as a fuse 88. It is prior art according to FIG. 3 under normal conditions to select a highly heat-resistant coating insulation according to DIN EN 60317 for the copper wire of the coil winding 16 to ensure high operating safety. This relies on the heat-resistant coating insulation holding up until the fuse 88 is promptly activated to interrupt the power supply. If no more energy is supplied, the operating magnet can also not burn through or begin to scorch. Unfortunately, the pertinent safety concept has not proven its value in practice and in this respect it results in electrical scorching and burning. In the prior art use is usually made of a winding wire according to DIN EN 60317-13 (1994).

In the solution of the invention according to FIG. 4, the coating insulation that is used for the coil wire has a low softening temperature, such that if even just a little heat builds up within presettable limits, a desired burning-through of the adjacent insulating layers occurs. This then has the result that the coil winding 16 is melted together, at least partially, to form a block that consists of the individual winding layers, in particular a copper line block, whereby said block is not easily destroyed by heat and which in particular disables the operating magnets—which also relates to the additional current consumption. In this case, the additional fuse 88 according to the known solution can even be completely eliminated.

By the premature melting away of the insulation, the possible fire risk at any rate is effectively counteracted, and for the coil winding 16, in the solution according to the invention, a winding wire according to DIN EN 60317, 1994 Edition, is inserted according to the parts 1, 2, 3, 4, 12, 19, 20, 21, 34 or a winding wire according to IEC 317, parts 1, 2, 3, 4, 12, 19, 20, 21, 34. The selected insulation material class is then always below a class size of the otherwise used wire insulation. To provide an especially effective safety apparatus, it is provided, however, that the melting point of the relevant components for the operating magnets or the operating apparatus is above the melting point of the coating insulation that is used for the electric wire in the form of copper wire. Thus, for example, the winding of copper wire melts with low heat class F at, for example, 130° C., while the coil formers 10, 12 that essentially consist of plastic have a melting point of 155° C. Comparable considerations also apply for the heat resistance of the otherwise used plastic components for the operating magnets.

In an especially preferred embodiment, several active and passive safety means can be used for an operating magnet. With the solution according to the invention, it is possible to achieve a clear increase in safety in the operation of pertinent operating magnets.

1. A safety apparatus for avoiding a potential fire risk in an operating magnet that can be supplied with electric current, with at least one coil former (14) that is arranged in a housing (76, 82) and on which a coil winding (16) is fitted, and with an operating part (20, 36) that is at least partially guided in the coil former (14), characterized in that at least parts of the operating magnet are equipped with active and/or passive safety means of the apparatus to effectively counteract the fire risk.

2. The safety apparatus according to claim 1, characterized in that an extinguishing medium, such as extinguishing foam, extinguishing gas, and extinguishing fluid, with inclusion of nanoparticulate extinguishing substances, is provided as an active safety means.

3. The safety apparatus according to claim 2, characterized in that
nitrogen is used as extinguishing gas, and melamine or melamine-containing active compounds are used as nitrogen vehicles,
aluminum trihydroxide (ATH) and/or magnesium hydroxide (MDH) are used as extinguishing fluid for the discharge of water,
ammonium polyphosphate (APP) is used as extinguishing foam, and
silicate and/or graphite is/are used as nanoparticulate extinguishing substances.

4. The safety apparatus according to claim 1, characterized in that as a passive safety means, substances that have a low flammability or that are flame-retardant are used, and/or safety means for the production of a kind of scoring for creating an early, non-critical failure case for the operating magnets.

5. The safety apparatus according to claim 1, characterized in that as passive safety means, substances are used, such as:
ammonium phosphate (AP)
ammonium polyphosphate (APP)
resorcinol bis-diphenylphosphate (PDP)
red phosphorus (RP)
tri-n-butyl phosphate (TBP)
tricresyl phosphate (TCP)
triphenyl phosphate (TPP),
which are at least partially components of the housing (26), the coil former (14), the insulation of the coil winding (16) and/or the plastic encapsulation (82) for the housing of the operating magnet.

6. The safety apparatus according to claim 4, characterized in that for the production of the coil winding (16) for the operating magnet a current-carrying wire is used, which is encased with insulation, which is selected for inducing an early failure case by electrical short-circuit of the coil winding (16) from an insulation material class, which melts through in time before the critical temperature for a possible fire is reached.

7. The safety apparatus according to claim 1, characterized in that by using the respective safety means, an additional electrical safeguard of the power supply circuit (57) with the coil winding (16), such as a fuse, is avoided.
